(19) United States
(12) Patent Application Publication
(10) Pub. No.: US 2026/0111641 A1
(43) Pub. Date: Apr. 23, 2026

(54) CIRCUIT SIMULATION METHOD

(71) Applicant: Kioxia Corporation, Tokyo (JP)

(72) Inventors: Noriyuki EGAWA, Yokohama (JP); Tetsuaki MATSUNAWA, Fujisawa (JP)

(73) Assignee: Kioxia Corporation, Tokyo (JP)

(21) Appl. No.: 19/076,553

(22) Filed: Mar. 11, 2025

(30) Foreign Application Priority Data
Oct. 23, 2024 (JP) 2024-186604

(51) Int. Cl. G06F 30/367; G06F 111/08

(52) U.S. Cl. CPC G06F 30/367; G06F 2111/08

(57) ABSTRACT

According to one embodiment, there is provided a circuit simulation method. The circuit simulation method includes acquiring multiple device characteristics under an operating terminal condition. circuit simulation method includes setting multiple model parameters corresponding to the multiple device characteristics. The circuit simulation method includes obtaining a single-objective function including the multiple model parameters. The circuit simulation method includes minimizing the single-objective function and adjusting the multiple model parameters. The circuit simulation method includes outputting the multiple adjusted model parameters to a circuit simulator.

### CROSS-REFERENCE TO RELATED APPLICATIONS

This application is based upon and claims the benefit of Japanese Patent Application No. 2024-186604, filed on Oct. 23, 2024; the entire contents of which are incorporated herein by reference.

### FIELD

Embodiments described herein relate generally to a circuit simulation method.

### BACKGROUND

A circuit simulation method simulates the operation of a device using multiple model parameters corresponding to multiple device characteristics. There is a need to improve the accuracy of simulations in circuit simulation methods.

### BRIEF DESCRIPTION OF THE DRAWINGS

FIG. 1 is a diagram illustrating the functional configuration of an information processing apparatus in which a circuit simulation method according to an embodiment is executed;

FIG. 2 is a diagram illustrating device characteristic data in an embodiment;

FIG. 3 is a diagram illustrating device characteristic data in an embodiment;

FIG. 4 is a data flow diagram illustrating the flow of information in a circuit simulation method according to an embodiment;

FIG. 5 is a diagram illustrating the hardware configuration of an information processing apparatus in which a circuit simulation method according to an embodiment is executed;

FIG. 6 is a flowchart illustrating an overview of a circuit simulation method according to an embodiment;

FIG. 7 is a flowchart illustrating details of a circuit simulation method according to an embodiment;

FIG. 8 is a flowchart illustrating a circuit simulation method according to a first modification of an embodiment;

FIG. 9 is a flowchart illustrating a circuit simulation method according to a second modification of an embodiment; and

FIG. 10 is a flowchart illustrating a circuit simulation method according to a third modification of an embodiment.

### DETAILED DESCRIPTION

In general, according to one embodiment, there is provided a circuit simulation method. The circuit simulation method includes acquiring multiple device characteristics under an operating terminal condition. circuit simulation method includes setting multiple model parameters corresponding to the multiple device characteristics. The circuit simulation method includes obtaining a single-objective function including the multiple model parameters. The circuit simulation method includes minimizing the single-objective function and adjusting the multiple model parameters. The circuit simulation method includes outputting the multiple adjusted model parameters to a circuit simulator.

Exemplary embodiments of a circuit simulation method will be explained below in detail with reference to the accompanying drawings. The present invention is not limited to the following embodiments.

### EMBODIMENTS

A circuit simulation method according to an embodiment simulates the operation of a device using multiple model parameters corresponding to multiple device characteristics, with implemented improvements to enhance simulation accuracy.

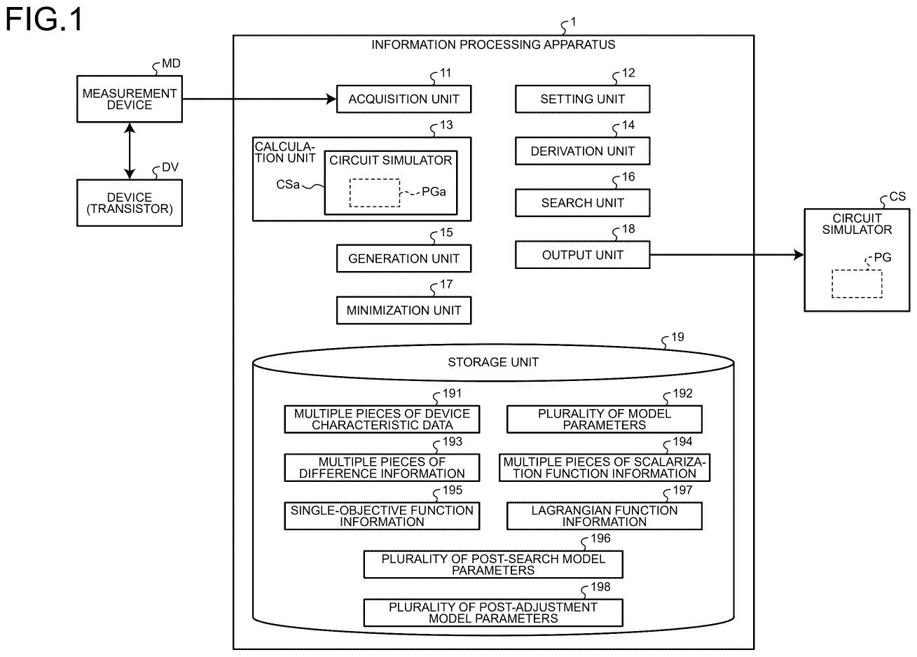

The circuit simulation method may be performed by an information processing apparatus 1 as illustrated in FIG. 1. FIG. 1 is a diagram illustrating the functional configuration of the information processing apparatus 1 in which the circuit simulation method according to the embodiment is executed.

The information processing apparatus 1 is connectable to a measurement device MD and a circuit simulator CS.

The measurement device MD has a measurement terminal, and is capable of measuring the operating characteristics of a device DV by connecting the measurement terminal to an operating terminal of the device DV. The device DV is, for example, a transistor, including a MOSFET-type transistor. The operating terminal includes a gate terminal, a source terminal, and a drain terminal. The measurement device MD is capable of measuring multiple device characteristics under an operating terminal condition of the device DV. The operating terminal condition includes a voltage, a current, or both, applied to the operating terminal.

The information processing apparatus 1 acquires the multiple device characteristics under the operating terminal condition from the measurement device MD. The information processing apparatus 1, upon acquiring the multiple device characteristics, activates a model extraction program 96 and sets multiple model parameters corresponding to the multiple device characteristics in accordance with the model extraction program 96.

The information processing apparatus 1 obtains a single-objective function including the multiple model parameters in accordance with the model extraction program 96. The information processing apparatus 1 calculates the multiple device characteristics under the operating terminal condition using the multiple model parameters. The information processing apparatus 1 generates an objective function using multiple differences between the multiple acquired device characteristics and the multiple calculated device characteristics.

For example, the information processing apparatus 1 generates multiple scalarization functions using the multiple differences and generates the single-objective function including the multiple scalarization functions. The information processing apparatus 1 may generate the single-objective function by taking a weighted root mean square of the multiple scalarization functions.

The information processing apparatus 1 minimizes the single-objective function and adjusts (e.g., optimizes) the multiple model parameters in accordance with the model extraction program 96. The information processing apparatus 1 uses a stochastic algorithm to minimize the single-objective function and adjust (e.g., optimize) the multiple model parameters.

For example, the information processing apparatus 1 may use a first stochastic algorithm to search for an initial value of the multiple parameters that are used to minimize the single-objective function. The information processing apparatus 1 may use a second stochastic algorithm to obtain the multiple model parameters that are used to minimize the single-objective function with the searched initial value.

The information processing apparatus 1 outputs the multiple adjusted model parameters to the circuit simulator CS.

The circuit simulator CS acquires the multiple adjusted model parameters from the information processing apparatus 1. The circuit simulator CS has a circuit simulation program PG. The circuit simulator CS is a device capable of executing the circuit simulation program PG. The circuit simulation program PG includes a SPICE (Simulation Program with Integrated Circuit Emphasis) simulation program. The model parameter includes a SPICE parameter. The circuit simulator CS sets the multiple adjusted model parameters in the circuit simulation program PG. This enables the circuit simulator CS to improve the accuracy of the simulation using the circuit simulation program PG.

The information processing apparatus 1 includes an acquisition unit 11, a setting unit 12, a calculation unit 13, a derivation unit 14, a generation unit 15, a search unit 16, a minimization unit 17, an output unit 18, and a storage unit 19. The calculation unit 13 has a circuit simulator CSa. The circuit simulator CSa has a similar function and configuration to the circuit simulator CS. The circuit simulator CSa has a circuit simulation program PGa and is capable of executing the circuit simulation program PGa. The circuit simulation program PGa has a similar function and configuration to the circuit simulation program PG.

The acquisition unit 11 is connectable to the measurement device MD. The measurement device MD generates multiple pieces of device characteristic data 191 as results obtained by measuring the multiple device characteristics. Upon the connection to the measurement device MD, the acquisition unit 11 acquires the multiple pieces of device characteristic data 191. The acquisition unit 11 may acquire the multiple pieces of device characteristic data 191 in a form associated with the operating terminal condition.

The multiple pieces of device characteristic data 191 indicate the multiple device characteristics under the operating terminal condition and differ in content. The operating terminal condition includes a gate voltage Vg, drain voltage Vd, substrate voltage Vb, source voltage Vs, or the like applied to the device DV during measurement. The multiple device characteristics may include gate voltage-drain current characteristics (hereinafter, Vg-Id characteristics), drain voltage-drain current characteristics (hereinafter, Vd-Id characteristics), substrate voltage-threshold voltage characteristics (hereinafter, Vb-Vth characteristics), gate length-threshold voltage characteristics (hereinafter, Lg-Vth characteristics), gate width-threshold current characteristics (hereinafter, Wg-Vth characteristics), temperature-threshold current characteristics (hereinafter, T-Vth characteristics), base voltage-on current characteristics (hereinafter, Vb-Ion characteristics), gate length-on current characteristics (hereinafter, Lg-Ion characteristics), gate width-on current characteristics (hereinafter, Wg-Ion characteristics), temperature-on current characteristics (hereinafter, T-Ion characteristics), gate voltage-gate capacitance characteristics (hereinafter, Vg-Cgg characteristics), drain voltage-gate capacitance characteristics (hereinafter, Vd-Cgg characteristics), and substrate voltage-substrate capacitance characteristics (hereinafter, Vb-Csb characteristics).

The multiple pieces of device characteristic data 191 can each be implemented as an array including a data series that is constituted with current characteristics or capacitance characteristics upon varying the applied voltage. Given the operating terminal condition, the array returns the measured value in the device characteristics.

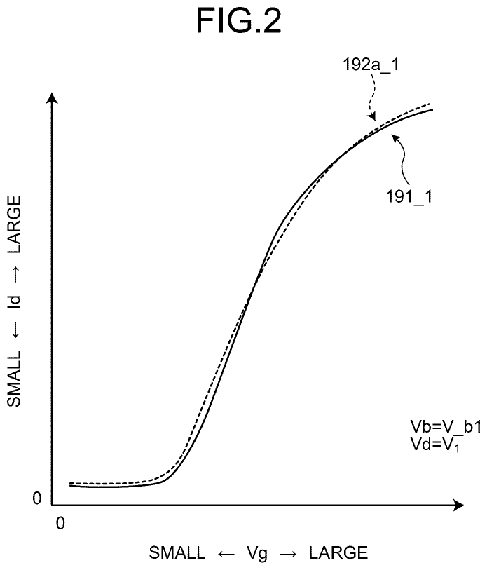

For example, the multiple pieces of device characteristic data 191 may include a piece of Vg-Id characteristic data 191_1 as indicated by the solid line in FIG. 2. In the piece of Vg-Id characteristic data 191_1 illustrated in FIG. 2, a drain current Id varies nonlinearly with respect to the gate voltage Vg under the operating terminal condition of Vb=V_b1 and Vd=V1.

The piece of Vg-Id characteristic data 191_1 can be implemented as an array including a data series that indicates the Vg-Id characteristics. The array, upon being given a set of values for the substrate voltage Vb, drain voltage Vd, and gate voltage Vg, returns a value of the drain current Id. The array may include, in addition to the applied voltage, an instance parameter that defines a MOSFET instance, such as temperature (hereinafter, T), gate width (hereinafter, Wg), gate length (hereinafter, Lg), distance from the gate end to the end of the diffusion layer region (hereinafter, SA or SB), drain-side contact resistance (hereinafter, RDC), source-side contact resistance (hereinafter, RSC), drain diffusion area (hereinafter, AD), and source diffusion area (hereinafter, AS).

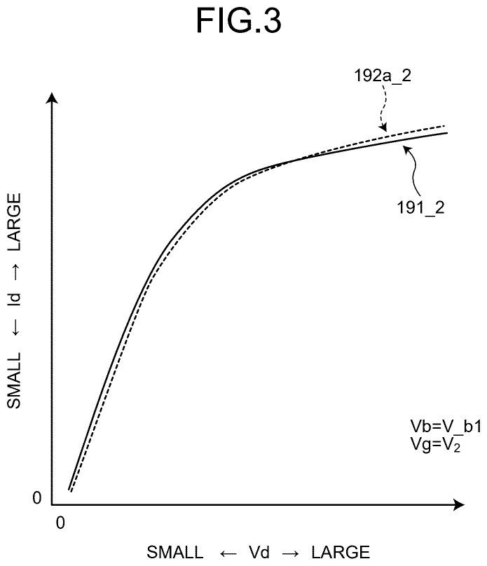

The multiple pieces of device characteristic data 191 may include a piece of Vd-Id characteristic data 191_2 as indicated by the solid line in FIG. 3. In the piece of Vd-Id characteristic data 191_2 illustrated in FIG. 3, the drain current Id varies nonlinearly with respect to the drain voltage Vd under the operating terminal condition of Vb=V_b1 and Vg=V2.

The piece of Vd-Id characteristic data 191_2 may be implemented as an array including a data series that indicates the Vd-Id characteristics. The array, upon being given a set of values for the substrate voltage Vb, gate voltage Vg, and drain voltage Vd, returns a value of the drain current Id.

The acquisition unit 11 supplies the multiple pieces of device characteristic data 191 to the derivation unit 14 and/or the storage unit 19 in a form associated with the operating terminal condition. The storage unit 19 may store each of the multiple pieces of device characteristic data 191 in a form associated with the operating terminal condition.

The setting unit 12 sets multiple model parameters 192. The multiple model parameters 192 correspond to the multiple device characteristics and differ in content. The multiple device characteristics may include Vg-Id characteristics, Vd-Id characteristics, Vb-Vth characteristics, Lg-Vth characteristics, Wg-Vth characteristics, T-Vth characteristics, Vb-Ion characteristics, Lg-Ion characteristics, Wg-Ion characteristics, T-Ion characteristics, Vg-Cgg characteristics, Vd-Cgg characteristics, and Vb-Csb characteristics. Each of the model parameters 192 may be a coefficient in a mathematical formula indicating the device characteristics. As previously described, each of the model parameters 192 includes the SPICE parameter.

The setting unit 12 sets a predetermined value for each of the multiple model parameters 192. The setting unit 12 may set a default value for each of the multiple model parameters 192. The setting unit 12 may acquire a current value of the multiple model parameters 192 from the search unit 16 and set the current value for each of the multiple model parameters 192.

The setting unit 12 stores the multiple model parameters 192, each with a set predetermined value, in the storage unit 19.

The calculation unit 13 reads the multiple model parameters 192 from the storage unit 19. The calculation unit 13 uses the multiple model parameters 192 to calculate the device characteristics under the operating terminal condition. In this case, the calculation unit 13 may use the circuit simulator CSa. The calculation unit 13 may set the multiple model parameters 192 in the circuit simulation program PGa and execute the circuit simulation program PGa on the circuit simulator CSa to calculate the multiple device characteristics under the operating terminal condition. The calculation unit 13 may apply the value for each of the multiple model parameters 192 to a mathematical formula indicating the device characteristics to obtain multiple pieces of device characteristic data 192a.

For example, the multiple pieces of device characteristic data 192a may include a piece of Vg-Id characteristic data 192a_1 as indicated by the dotted line in FIG. 2. In the piece of Vg-Id characteristic data 192a_1 illustrated in FIG. 2, the drain current Id varies nonlinearly with respect to the gate voltage Vg under the operating terminal condition of Vb=0 and Vd=V1.

The piece of Vg-Id characteristic data 192a_1 can be implemented as an array including a data series indicating the Vg-Id characteristics. The array, upon being given a set of values for the substrate voltage Vb, the drain voltage Vd, and the gate voltage Vg, returns a value for the drain current Id. The array may include, in addition to the applied voltage, an instance parameter that defines a MOSFET instance, such as temperature (hereinafter, T), gate width (hereinafter, Wg), gate length (hereinafter, Lg), distance from the gate end to the end of the diffusion layer region (hereinafter, SA or SB), drain-side contact resistance (hereinafter, RDC), source-side contact resistance (hereinafter, RSC), drain diffusion area (hereinafter, AD), and source diffusion area (hereinafter, AS).

The multiple pieces of device characteristic data 192a may include a piece of Vd-Id characteristic data 192a_2, as indicated by the dotted line in FIG. 3. In the piece of Vd-Id characteristic data 192a_2 illustrated in FIG. 3, the drain current Id varies nonlinearly with respect to the drain voltage Vd under the operating terminal condition of Vb=0 and Vg=V2.

The piece of Vd-Id characteristic data 192a_2 can be implemented as an array including a data series indicating the Vd-Id characteristics. The array, upon being given a set of values for the substrate voltage Vb, the gate voltage Vg, and the drain voltage Vd, returns a value of the drain current Id.

The calculation unit 13 supplies the multiple pieces of device characteristic data 192a to the derivation unit 14 in a form associated with the operating terminal condition.

The derivation unit 14 acquires the multiple pieces of device characteristic data 191 from the calculation unit 13 or the storage unit 19 in a form associated with the operating terminal condition. The derivation unit 14 acquires the multiple pieces of device characteristic data 192a from the calculation unit 13 in a form associated with the operating terminal condition. The derivation unit 14 specifies multiple sets of the multiple pieces of device characteristic data 191 and the multiple pieces of device characteristic data 192a, where each set corresponds to the operating terminal condition.

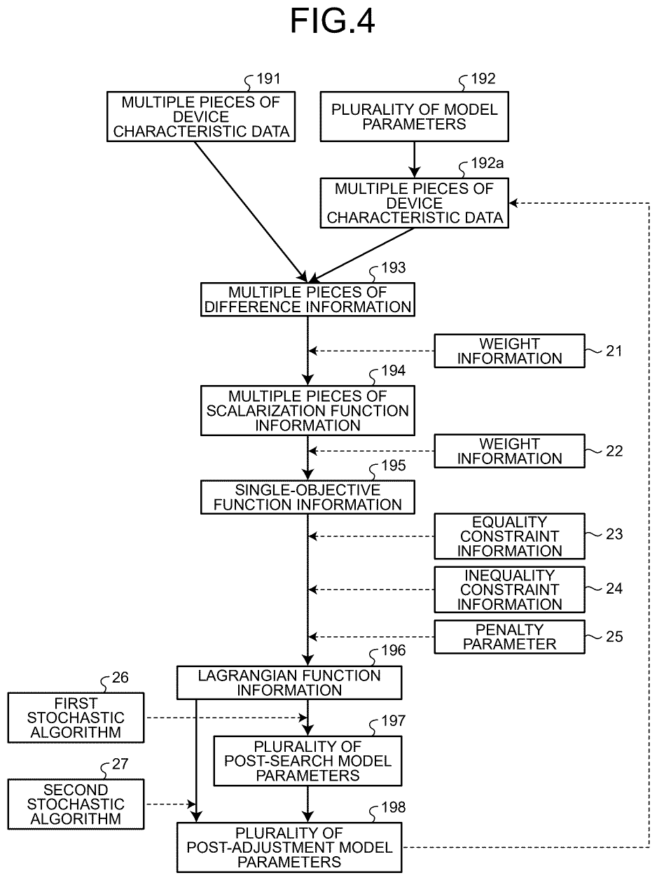

The derivation unit 14, as illustrated in FIG. 4, derives multiple differences between the multiple sets of device characteristic data 191 and device characteristic data 192a and generates multiple pieces of difference information 193. FIG. 4 is a data flow diagram illustrating the flow of information in the circuit simulation method.

Each of the multiple differences corresponds to an error between the device characteristics measured by the measurement device MD and the device characteristics calculated by the calculation unit 13.

The difference calculated by the derivation unit 14 corresponds to, for example, an error between the Vg-Id characteristics indicated by the solid line in FIG. 2 and the Vg-Id characteristics indicated by the dotted line. Alternatively, the difference corresponds to an error between the Vd-Id characteristics indicated by the solid line in FIG. 3 and the Vd-Id characteristics indicated by the dotted line.

The multiple differences may include a current difference ΔIi(x) of the Vg-Id characteristics, a logarithmic difference Δ log Ii(x) of the Vg-Id characteristics, a differential difference Δgmi(x) of the Vg-Id characteristics, a current difference ΔIi(x) of the Vd-Id characteristics, a logarithmic difference Δ log Ii(x) of the Vd-Id characteristics, and a differential difference Δgdsi(x) of the Vd-Id characteristics.

The derivation unit 14 may obtain the current difference ΔIi(x) of the Vg-Id characteristics using the following Formula 1.

$$Δ {I}_{1} ( x ) = \vert \frac{{I}_{i}^{sim} ( x ) - {I}_{i}^{meas}}{{I}_{i}^{threshold}} \vert \qquad Formula 1$$

In Formula 1, Iᵢ^{sim} represents the calculated value of the drain current Id in the i-th device characteristics. Iᵢ^{meas} represents the measured value of the i-th drain current Id.

$${I}_{i}^{threshold}$$

represents a coefficient for normalization and can be selected optionally, but the maximum value of the current under the same bias condition may be selected as represented in the following Formula 2.

$$max \{ {I}_{j}^{meas} \vert {T}_{j} = {T}_{i} , {W}_{j} = {W}_{i} , {L}_{j} = {L}_{i} , {V}_{{d}_{j}} = {V}_{{d}_{i}} \} \qquad Formula 2$$

Formula 2 represents the largest value among the measured values of the drain current Id at the same temperature T, channel width W, channel length L, and drain voltage Vd as the measured value of the j-th drain current Id. Since the current value of a transistor varies significantly depending on the device length and bias conditions, by adopting Formula 2 in the denominator of Formula 1, it is possible to normalize the difference by dividing into groups under a specific condition. In Formula 2, Tᵢ represents the temperature at the i-th measured value. Wi represents the channel width at the i-th measured value. Li represents the channel length at the i-th measured value. Vdi represents the drain voltage at the i-th measured value.

The derivation unit 14 may obtain the logarithmic difference Δ log Ii(x) of the Vg-Id characteristics using the following Formula 3.

$$Δlog {I}_{i} ( x ) = \vert \frac{\vert log {I}_{i}^{sim} ( x ) \vert - \vert log {I}_{i}^{meas} \vert}{log \vert {I}_{i}^{log - thresh} \vert} \vert \qquad Formula 3$$

In Formula 3, log|Iᵢ^{sim}| represents the common logarithm of the calculated drain current Id in the i-th device characteristics. log|Iᵢ^{meas}| represents the common logarithm of the measured value of the i-th drain current Id.

$$log \vert {I}_{i}^{log - thresh} \vert$$

represents a coefficient for normalization and can be selected optionally, but the maximum value of the current at the same bias condition may be selected as represented in the following Formula 4.

$$max \{ log \vert {I}_{j}^{meas} \vert \vert {T}_{j} = {T}_{i} , {W}_{j} = {W}_{i} , {L}_{j} = {L}_{i} , {V}_{{d}_{j}} = {V}_{{d}_{i}} \} \qquad Formula 4$$

Formula 4 represents the largest value among the measured values of the drain current Id at the same temperature T, channel width W, channel length L, and drain voltage Vd as the measured value of the j-th drain current Id.

The derivation unit 14 may obtain the differential difference Δgmi(x) of the Vg-Id characteristics using the following Formula 5.

$$Δ {gm}_{i} ( x ) = \vert \frac{\frac{\partial }{\partial {V}_{g}} {I}_{i}^{sim} ( x ) - \frac{\partial }{\partial {V}_{g}} {I}_{i}^{meas}}{\frac{\partial }{\partial {V}_{g}} {I}_{i}^{gm - thresh}} \vert \qquad Formula 5$$

In Formula 5, ∂Iᵢ^{sim}/∂Vg represents the value obtained by differentiating the calculated drain current Id in the i-th device characteristics with respect to the gate voltage Vg. ∂Iᵢ^{meas}/∂Vg represents the value obtained by differentiating the measured value of the i-th drain current Id with respect to the gate voltage Vg.

$$\frac{\partial }{\partial {V}_{g}} {I}_{i}^{gm - thresh}$$

represents a coefficient for normalization and can be selected optionally, but the maximum value of the current under the same bias condition may be selected, as represented in the following Formula 6.

$$max \{ \frac{\partial }{\partial {V}_{g}} {I}_{j}^{meas} \vert {T}_{j} = {T}_{i} , {W}_{j} = {W}_{i} , {L}_{j} = {L}_{i} , {V}_{{d}_{j}} = {V}_{{d}_{i}} \} \qquad Formula 6$$

Formula 6 represents the largest value among the measured values of the drain current Id at the same temperature T, channel width W, channel length L, and drain voltage Vd as the measured value of the j-th drain current Id.

The derivation unit 14 may obtain the current difference ΔIi(x) of the Vd-Id characteristics using Formula 1. In this case, the following Formula 7 may be adopted as the denominator of Formula 1 instead of Formula 2.

$$max \{ {I}_{j}^{meas} \vert {T}_{j} = {T}_{i} , {W}_{j} = {W}_{i} , {L}_{j} = {L}_{i} , {V}_{{b}_{j}} = {V}_{{b}_{i}} \} \qquad Formula 7$$

Formula 7 represents the largest value among the measured values of the drain current Id at the same temperature T, channel width W, channel length L, and substrate voltage Vb as the measured value of the j-th drain current Id. In Formula 7, Vbi represents the substrate voltage at the i-th measured value.

The derivation unit 14 may obtain the logarithmic difference Δ log Ii(x) of the Vd-Id characteristics using Formula 2. In this case, the following Formula 8 may be used in place of Formula 4 in the denominator of Formula 2.

$$max \{ log \vert {I}_{j}^{meas} \vert \vert {T}_{j} = {T}_{i} , {W}_{j} = {W}_{i} , {L}_{j} = {L}_{i} , {V}_{{b}_{j}} = {V}_{{b}_{i}} \} \qquad Formula 8$$

Formula 8 represents the largest value among the measured values of the drain current Id at the same temperature T, channel width W, channel length L, and substrate voltage Vb as the measured value of the j-th drain current Id.

The derivation unit 14 may obtain the differential difference Δgdsi(x) of the Vd-Id characteristics using Formula 9.

$$Δ {gds}_{i} ( x ) = \vert \frac{\frac{\partial }{\partial {V}_{d}} {I}_{i}^{sim} ( x ) - \frac{\partial }{\partial {V}_{d}} {I}_{i}^{meas}}{\frac{\partial }{\partial {V}_{d}} {I}_{i}^{gds - thresh}} \vert \qquad Formula 9$$

In Formula 9, ∂Iᵢ^{sim}/∂Vg represents the value obtained by differentiating the calculated drain current Id in the i-th device characteristics with respect to the drain voltage Vd. ∂Iᵢ^{meas}/∂Vg represents the value obtained by differentiating the measured value of the i-th drain current Id with respect to the drain voltage Vd.

$$\frac{\partial }{\partial {V}_{d}} {I}_{i}^{gds - thresh}$$

represents a coefficient for normalization and can be selected optionally, but the maximum value of the current under the same bias condition may be selected, as represented in the following Formula 10.

$$max \{ \frac{\partial }{\partial {V}_{g}} {I}_{j}^{meas} \vert {T}_{j} = {T}_{i} , {W}_{j} = {W}_{i} , {L}_{j} = {L}_{i} , {V}_{{b}_{j}} = {V}_{{b}_{i}} \} \qquad Formula 10$$

Formula 10 represents the largest value among the measured values of the drain current Id at the same temperature T, channel width W, channel length L, and substrate voltage Vb as the measured value of the j-th drain current Id.

The derivation unit 14 supplies the multiple pieces of difference information 193 to the generation unit 15 and/or the storage unit 19.

The generation unit 15 acquires the multiple pieces of difference information 193 from the derivation unit 14 or the storage unit 19. The generation unit 15 generates multiple pieces of scalarization function information 194 using weight information 21 depending on the multiple pieces of difference information 193, as illustrated in FIG. 4. The weight information 21 can be pre-set in the generation unit 15. The multiple pieces of scalarization function information 194 represents multiple scalarization functions using multiple differences.

The generation unit 15 may generate the scalarization function by representing the Vg-Id characteristics as a combination of a relative error, a logarithm of Id, and a derivative of Vg with respect to Id, and further representing these as a single scalar value using the scalarization function. This approach enables the generation unit 15 to generate the scalarization function for the Vg-Id characteristics, equivalent to scalarizing a vector of multiple parameters.

The generation unit 15 may generate the scalarization function by representing the Vd-Id characteristics as a combination of a relative error, a logarithm of Id, and a derivative of Vd with respect to Id, and further representing these as a single scalar value using the scalarization function. This approach enables the generation unit 15 to generate the scalarization function for the Vd-Id characteristics, equivalent to scalarizing a vector of multiple parameters.

For example, the generation unit 15 may generate a scalarization function ΔIdVgi(x) as represented in the following Formula 11 by a weighted summation of the current difference ΔIi(x) of the Vg-Id characteristics, logarithmic difference Δ log Ii(x) of the Vg-Id characteristics, and differential difference Δgmi(x) of the Vg-Id characteristics.

$$Δ {I}_{d} {V}_{{g}_{i}} ( x ) = {A}_{{I}_{d} {V}_{g}} Δ {I}_{i} ( x ) + {A}_{log {I}_{d} {V}_{g}} Δ log {I}_{i} ( x ) + {A}_{gm} Δ {gm}_{i} ( x ) \qquad Formula 11$$

In Formula 11, A_{IdVg} represents the weight assigned to the current difference ΔIi(x) of the Vg-Id characteristics. A_{log IdVg} represents the weight assigned to the logarithmic difference Δ log Ii(x) of the Vg-Id characteristics. A_{gm} represents the weight assigned to the differential difference Δgmi(x) of the Vg-Id characteristics. Each of A_{IdVg}, A_{log IdVg}, and A_{gm} can be experimentally obtained in advance and set in the generation unit 15 as weight information 21 (see FIG. 4).

The generation unit 15 may generate a scalarization function ΔIdVdi(x) as represented in the following Formula 12 by a weighted summation of the current difference ΔIi(x) of the Vd-Id characteristics, the logarithmic difference Δ log Ii(x) of the Vd-Id characteristics, and the differential difference Δgdsi(x) of the Vd-Id characteristics.

$$Δ {I}_{d} {V}_{{d}_{i}} ( x ) = {A}_{{I}_{d} {V}_{d}} Δ {I}_{i} ( x ) + {A}_{{logI}_{d} {V}_{d}} Δ {log I}_{i} ( x ) + {A}_{gds} Δ {gds}_{i} ( x ) \qquad Formula 12$$

In Formula 12, A_{IdVd} represents the weight assigned to the current difference ΔIi(x) of the Vd-Id characteristics. A_{log IdVd} represents the weight assigned to the logarithmic difference Δ log Ii(x) of the Vd-Id characteristics. A_{gds} represents the weight assigned to the differential difference Δgdsi(x) of the Vd-Id characteristics. Each of A_{IdVd}, A_{log IdVd}, and A_{gds} can be experimentally obtained in advance and set in the generation unit 15 as the weight information 21 (see FIG. 4).

Alternatively, the generation unit 15 may generate the scalarization function ΔIdVgi(x) as represented in the following Formula 13 by weighting the current difference ΔIi(x), logarithmic difference Δ log Ii(x), and differential difference Δgmi(x) of the Vg-Id characteristics and taking the maximum value among them.

$$Δ {I}_{d} {V}_{{g}_{i}} ( x ) = max \{ {A}_{{I}_{d} {V}_{g}} Δ {I}_{i} ( x ) , {A}_{{logI}_{d} {V}_{g}} Δ {log I}_{i} ( x ) , {A}_{gm} Δ {gm}_{i} ( x ) \qquad Formula 13$$

Formula 13 corresponds to obtaining the value of a Chebyshev function for the current difference ΔIi(x) of the Vg-Id characteristics, the logarithmic difference Δ log Ii(x) of the Vg-Id characteristics, and the differential difference Δgmi(x) of the Vg-Id characteristics.

The generation unit 15 may generate the scalarization function ΔIdVdi(x) as represented by the following Formula 14 by weighting the current difference ΔIi(x) of the Vd-Id characteristics, the logarithmic difference Δ log Ii(x) of the Vd-Id characteristics, and the differential difference Δgdsi(x) of the Vd-Id characteristics and taking the maximum value among them.

$$Δ {I}_{d} {V}_{{d}_{i}} ( x ) = max \{ {A}_{{I}_{d} {V}_{d}} Δ {I}_{i} ( x ) , {A}_{{logI}_{d} {V}_{d}} Δ {log I}_{i} ( x ) , {A}_{gds} Δ {gds}_{i} ( x ) \qquad Formula 14$$

Formula 14 corresponds to obtaining the value of the Chebyshev function for the current difference ΔIi(x) of the Vd-Id characteristics, the logarithmic difference Δ log Ii(x) of the Vd-Id characteristics, and the differential difference Δgdsi(x) of the Vd-Id characteristics.

The generation unit 15 generates single-objective function information 195 using weight information 22 as illustrated in FIG. 4 depending on the multiple pieces of scalarization function information 194. The weight information 22 can be pre-set in the generation unit 15. The single-objective function information 195 indicates a single-objective function.

The generation unit 15 generates a single-objective function f(x) that includes multiple scalarization functions. The generation unit 15 may generate the single-objective function f(x) by taking the weighted root mean square of the multiple scalarization functions. This enables the generation unit 15 to generate a single-objective function f(x) that is equivalent to making multiple objectives corresponding to multiple device characteristics into a single objective.

This approach is equivalent to describing the definition regarding the error between the device characteristics measured by the measurement device MD and the device characteristics calculated by the calculation unit 13 in a single function. This simplifies complex transistor characteristics into a single objective, and enables the use of a wide range of optimization methods for parameter extraction.

For example, the generation unit 15 may obtain the single-objective function f(x) that includes the multiple scalarization functions using the following Formula 15.

$$f ( x ) = \sqrt{\frac{{\sum }_{i , j} \{ {{w}_{i}^{{I}_{d} {V}_{g}} ( Δ {I}_{d} {V}_{{g}_{i}} ( x ) )}^{2} + {{w}_{j}^{{I}_{d} {V}_{d}} ( Δ {I}_{d} {V}_{{d}_{j}} ( x ) )}^{2} \}}{{\sum }_{i , j} \{ {w}_{i}^{{I}_{d} {V}_{g}} + {w}_{j}^{{I}_{d} {V}_{d}} \}}} \qquad Formula 15$$

In Formula 15, wᵢ^{IdVg} represents the weight assigned to the i-th scalarization function. wⱼ^{IdVd} represents the weight assigned to the j-th scalarization function.

Formula 15 represents the generation of the single-objective function f(x) by taking the weighted root mean square of the scalarization function ΔIdVgi(x) for the Vg-Id characteristics and the scalarization function ΔIdVdj(x) for the Vd-Id characteristics.

This is equivalent to calculating a weighted average of multiple errors between the device characteristics measured by the measurement device MD and the device characteristics calculated by the calculation unit 13 using the weighted root mean square. In other words, the generation unit 15 is capable of generating the single-objective function f(x) that appropriately represents multiple errors.

The generation unit 15 supplies the single-objective function information 195 to the search unit 16 and/or the storage unit 19.

The search unit 16 acquires the single-objective function information 195 from the generation unit 15 or the storage unit 19. The search unit 16 generates Lagrangian function information 196 using equality constraint information 23, inequality constraint information 24, and penalty parameter 25 depending on the single-objective function information 195, as illustrated in FIG. 4. The equality constraint information 23, the inequality constraint information 24, and the penalty parameter 25 can each be pre-set in the search unit 16. The Lagrangian function information 196 indicates a Lagrangian function L(x, λ, μ) that includes the single-objective function f(x).

For example, the search unit 16 may generate the Lagrangian function L(x, λ, μ) that includes the single-objective function f(x) in accordance with the augmented Lagrangian method, as represented by the following Formula 16.

$${L}_{p} ( x , λ , μ ) = f ( x ) + \frac{ρ}{2} [ {\sum }_{i = 1}^{m} {( {h}_{i} ( x ) + \frac{{λ}_{i}}{ρ} )}^{2} + {\sum }_{i = 1}^{p} max {\{ 0 , {g}_{i} ( x ) + \frac{{μ}_{i}}{ρ} \}}^{2} ] \qquad Formula 16$$

In Formula 16, f(x) is the single-objective function generated by the generation unit 15. ρ is the penalty parameter in the augmented Lagrangian method. The penalty parameter can be pre-set in the search unit 16 as the penalty parameter 25. m represents the number of equality constraints. The equality constraints are constraints as represented in the following Formula 17.

$$h ( x ) = 0 \qquad Formula 17$$

In Formula 16, hi(x) represents the i-th equality constraint. λi is the Lagrange undetermined multiplier of the i-th equality constraint. p represents the number of inequality constraints. The inequality constraints are constraints as represented in the following Formula 18.

$$g ( x ) \leq 0 \qquad Formula 18$$

In Formula 16, gi(x) represents the i-th inequality constraint. μi is the Lagrange undetermined multiplier of the i-th inequality constraint.

The generation of the Lagrangian function L(x, λ, μ) enables the minimization of the single-objective function f(x) while considering multiple equality constraints and/or multiple inequality constraints.

The multiple equality constraints may include a Vth equality constraint, an Ion equality constraint, and an S-factor equality constraint.

The Vth equality constraint is represented by the following Formula 19.

$$- Vth = 0 \qquad Formula 19$$

In Formula 19, Vth\hat{ } represents a threshold voltage obtained by simulation. Vth represents a target threshold voltage.

The Ion equality constraint is represented by the following Formula 20.

$$- Ion = 0 \qquad Formula 20$$

In Formula 20, Ion\hat{ } represents an on-current obtained by simulation. Ion represents a target on-current. Moreover, the multiple equality constraints may include an Ioff equality constraint instead of the Ion equality constraint. The Ioff equality constraint is obtained by replacing Ion\hat{ } with the off-current Ioff\hat{ } obtained using simulation and replacing Ion with the target off-current Ioff.

The S-factor equality constraint is represented by the following Formula 21.

$$\hat{S} - S = 0 \qquad Formula 21$$

In Formula 21, S\hat{ } represents the S-factor obtained by simulation. S represents the target S-factor. The S-factor can be defined as the gate voltage Vg required to change the drain current Id by one order of magnitude, as represented in the following Formula 22.

$$S = ln ( 10 ) \frac{{dV}_{g}}{d ( ln ( Id ) )} \qquad Formula 22$$

The multiple inequality constraints may include a Vth inequality constraint, an Ion inequality constraint, a Gm inequality constraint, and an S-factor inequality constraint.

The Vth inequality constraint is represented by the following Formula 23.

$$- Vth \leq {τ}_{Vth} \qquad Formula 23$$

In Formula 23, Vth\hat{ } represents the threshold voltage obtained by simulation. Vth represents the target threshold voltage. τᵥₜₕ represents a tolerance.

The Ion inequality constraint is represented by the following Formula 24.

$$- Ion \leq {τ}_{Ion} \qquad Formula 24$$

In Formula 24, Ion\hat{ } represents the on-current obtained by simulation. Ion represents the target on-current. τᵥₜₕ represents the tolerance. Moreover, the multiple inequality constraints may include the Ioff equality constraint instead of the Ion equality constraint. The Ioff equality constraint is obtained by replacing Ion\hat{ } with the off-current Ioff\hat{ } obtained using simulation and replacing Ion with the target off-current Ioff.

The Gm inequality constraint is represented by the following Formula 25.

$$Gm \leq \qquad Formula 25$$

In Formula 25, Gm\hat{ } represents a negative resistance Gm obtained by simulation. Gm represents a target negative resistance Gm. The multiple inequality constraints may include a Gds inequality constraint instead of the Gm inequality constraint. The Gds inequality constraint is obtained by replacing Gm\hat{ } with the negative resistance Gds\hat{ } obtained using simulation and replacing Gm with the target negative resistance Gds.

The S-factor inequality constraint is represented by the following Formula 26.

$$\hat{S} - S \leq {τ}_{s} \qquad Formula 26$$

In Formula 26, S\hat{ } represents the S-factor obtained by simulation. S represents the target S-factor. τ_{S} represents the tolerance.

The search unit 16 searches for an initial value of the single-objective function f(x) in the Lagrangian function information 196 using a first stochastic algorithm 26 as illustrated in FIG. 4, and generates multiple post-search model parameters 197. The first stochastic algorithm 26 includes a NPSA (Neighborhood Parallel Simulated Annealing) algorithm.

The use of the stochastic algorithm for the Lagrangian function L(x, λ, μ) makes it possible to extract a highly accurate model parameter that satisfactorily represents measured data under multiple constraint conditions.

The search unit 16 may search for an initial value of x for the single-objective function by searching for x that minimizes the Lagrangian function L(x, λ, μ) using the first stochastic algorithm 26.

For example, the search unit 16 applies simulated annealing in parallel to the current value of x to obtain the x that minimizes L. The search unit 16, depending on the amount of violation of multiple equality constraints and/or inequality constraints for the found x, updates the values of λ and μ, and again obtains x that minimizes L. Similar processing is repeated until the found x satisfies the multiple equality constraints and/or inequality constraints, or until a predetermined number of iterations is reached.

Upon completion of the initial value search, the search unit 16 supplies the Lagrangian function information 196 and the multiple post-search model parameters 197 to the minimization unit 17 and/or the storage unit 19.

The minimization unit 17 acquires the Lagrangian function information 196 and the multiple post-search model parameters 197 from the search unit 16 or the storage unit 19. The minimization unit 17 minimizes the single-objective function f(x) using a second stochastic algorithm 27 as illustrated in FIG. 4, depending on the Lagrangian function information 196 and the multiple post-search model parameters 197, and further adjusts the multiple model parameters 197 and generates multiple post-adjustment model parameters 198. The second stochastic algorithm 26 includes an ADAM (ADAptive Moment estimation) algorithm.

The further use of the stochastic algorithm for the Lagrangian function L(x, λ, μ) makes it possible to extract even more highly accurate model parameters that satisfactorily represent actual measurement data under the multiple constraint conditions.

The minimization unit 17 may obtain x that minimizes the single-objective function f(x) by searching for x that minimizes the Lagrangian function L(x, λ, μ) using the second stochastic algorithm 27.

For example, the minimization unit 17 fixes the values of λ and μ, and again sets the current value of x as the initial value to L. The minimization unit 17 stochastically changes the x in the direction of the gradient while considering the squared mean square of gradient and its mean as the first and second moments. The minimization unit 17 updates the values of λ and μ depending on the amount of violation of the obtained x against the multiple equality constraints and/or multiple inequality constraints, and again sets the current value of x as the initial value to L to obtain the minimized x. Similar processing is repeated until the obtained x satisfies the multiple equality constraints and/or multiple inequality constraints, or until a predetermined number of iterations is reached.

The minimization unit 17, upon completion of the minimization, supplies the multiple post-adjustment model parameters 198 to the output unit 18 and/or the storage unit 19.

The output unit 18 acquires the multiple post-adjustment model parameters 198 from the minimization unit 17 or the storage unit 19. The output unit 18 outputs the multiple post-adjustment model parameters 198 to the circuit simulator CS.

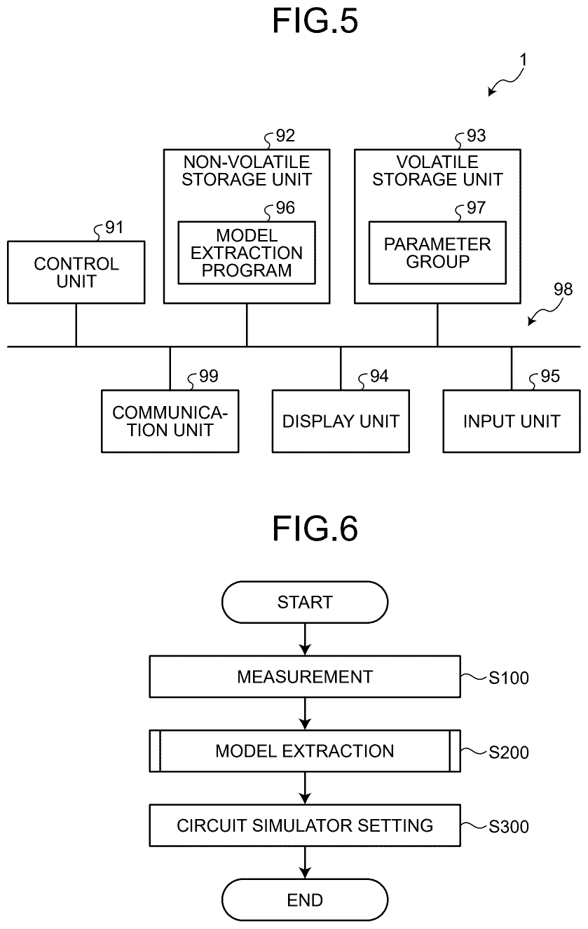

The hardware configuration of the information processing apparatus 1 is now described with reference to FIG. 5. FIG. 5 is a diagram illustrating the hardware configuration of the information processing apparatus 1.

The information processing apparatus 1 includes a control unit 91, a non-volatile storage unit 92, a volatile storage unit 93, a display unit 94, an input unit 95, and a communication unit 99. The control unit 91, the non-volatile storage unit 92, the volatile storage unit 93, the display unit 94, and the input unit 95 are interconnected and capable of communicating with each other via a bus line 98.

The control unit 91 exercises overall control over all components of the information processing apparatus 1. The control unit 91 can be implemented using a central processing unit (CPU) or the like.

The non-volatile storage unit 92 stores the model extraction program 96 in a non-volatile manner. The non-volatile storage unit 92 can be implemented using read-only memory (ROM), flash memory, or the like.

The control unit 91 reads the model extraction program 96 from the non-volatile storage unit 92, activates the program, and then executes the circuit simulation method in accordance with the model extraction program 96.

The volatile storage unit 93 is used for temporary storage of information. The volatile storage unit 93 may store a parameter group 97 in accordance with the model extraction program 96. The volatile storage unit 93 can be implemented using a dynamic random-access memory (DRAM), or the like.

The display unit 94 displays information under the control of the control unit 91. The display unit 94 can be implemented using a display such as a liquid crystal monitor.

The input unit 95 receives information from external sources and supplies the received information to the control unit 91. The control unit 91 may perform processing corresponding to the information in accordance with the model extraction program 96.

The communication unit 99 is capable of communicating with an external source via a communication line. The communication line may be a wired communication line or a wireless communication line.

The acquisition unit 11 and the output unit 18 illustrated in FIG. 1 can be implemented using the input unit 95 or the communication unit 99. The storage unit 19 illustrated in FIG. 1 can be implemented using the volatile storage unit 93.

The setting unit 12, the calculation unit 13, the derivation unit 14, the generation unit 15, the search unit 16, and the minimization unit 17 illustrated in FIG. 1 may all be implemented in software. In this case, the calculation unit 13, the derivation unit 14, the generation unit 15, the search unit 16, and the minimization unit 17 may each be implemented as a functional module deployed on the volatile storage unit 93 collectively at the time of compilation or sequentially as the progress of processing in response to the activation of the model extraction program 96 by the control unit 91.

Alternatively, the setting unit 12, the calculation unit 13, the derivation unit 14, the generation unit 15, the search unit 16, and the minimization unit 17 illustrated in FIG. 1 may all be implemented in hardware. In this case, the setting unit 12, the calculation unit 13, the derivation unit 14, the generation unit 15, the search unit 16, and the minimization unit 17 can each be incorporated as a circuit in the control unit 91.

Alternatively, some of the setting unit 12, the calculation unit 13, the derivation unit 14, the generation unit 15, the search unit 16, and the minimization unit 17 illustrated in FIG. 1 may be partially implemented in software, while others may be partially or fully implemented in hardware.

An overview of the circuit simulation method is now described with reference to FIG. 6. FIG. 6 is a flow chart illustrating an overview of the circuit simulation method.

The measurement device MD measures the multiple device characteristics for the device DV (S100) and generates the multiple pieces of device characteristic data 191.

The information processing apparatus 1, upon acquiring the multiple pieces of device characteristic data 191 from the measurement device MD, activates the model extraction program 96 and performs model extraction processing using the multiple pieces of device characteristic data 191 in accordance with the model extraction program 96 (S200). The information processing apparatus 1 adjusts multiple model parameters by the model extraction processing (S200) and outputs the multiple post-adjustment model parameters 198 to the circuit simulator CS.

The circuit simulator CS, upon acquiring the multiple post-adjustment model parameters 198, sets the multiple post-adjustment model parameters 198 in the circuit simulation program PG (S300).

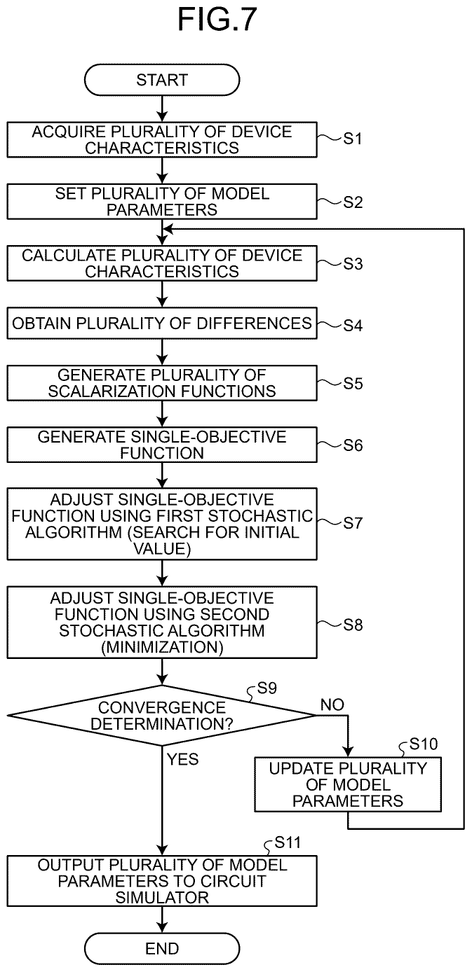

Subsequently, the details of the circuit simulation method are described with reference to FIG. 7. FIG. 7 is a flowchart illustrating the details of the circuit simulation method and specifically illustrates the details of the model extraction processing (S200).

The information processing apparatus 1, upon acquiring the multiple device characteristics (S1), sets the multiple model parameters corresponding to the multiple device characteristics (S2).

The information processing apparatus 1 calculates the multiple device characteristics using the multiple model parameters set in S2 (S3).

The information processing apparatus 1 obtains the multiple differences between the multiple device characteristics acquired in S1 and the multiple device characteristics calculated in S3 (S4).

The information processing apparatus 1 generates the multiple scalarization functions using the multiple differences (S5) and generates the single-objective function including the multiple scalarization functions (S6).

The information processing apparatus 1 adjusts (e.g., optimizes) the single-objective function using the first stochastic algorithm and searches for an initial value for the single-objective function (S7).

The information processing apparatus 1 sets the initial value obtained in S7 to the single-objective function, adjusts (e.g., optimizes) the single-objective function using the second stochastic algorithm, and obtains the multiple model parameters that minimize the single-objective function (S8).

The information processing apparatus 1 performs a convergence determination (S9).

The information processing apparatus 1, if the multiple model parameters do not satisfy multiple equality constraints and/or multiple inequality constraints, determines that convergence is not achieved (No in S9), updates the multiple model parameters (S10), and then returns the processing to S3.

The information processing apparatus 1, if the multiple model parameters satisfy the multiple equality constraints and/or the multiple inequality constraints, determines that convergence is achieved (Yes in S9), outputs the multiple model parameters to the circuit simulator CS (S111), and then terminates the processing.

As described above, in the embodiment, in the circuit simulation method, a single-objective function including multiple model parameters is obtained, the single-objective function may be minimized to adjusts (e.g., optimizes) the multiple model parameters, and the multiple adjusts (e.g., optimizes) model parameters may be output to the circuit simulator CS. This allows the multiple post-adjustment model parameters to be set in the circuit simulation program PG in the circuit simulator CS. As a result, an improvement in the accuracy of the simulation performed using the circuit simulation program PG in the circuit simulator CS may be achieved.

It should be noted that the information processing apparatus 1 may acquire the multiple pieces of device measurement data 191 from a TCAD simulator TS instead of the measurement device MD. Although the TCAD simulator TS is capable of executing a process simulation, if the parameters of the process simulation are previously improved in accuracy using the measured values of the device DV, it is possible to generate multiple pieces of device characteristic data that closely match the measured values.

Alternatively, in the model extraction processing (S200), the processing of adjusting the multiple model parameters may be performed in a single stage.

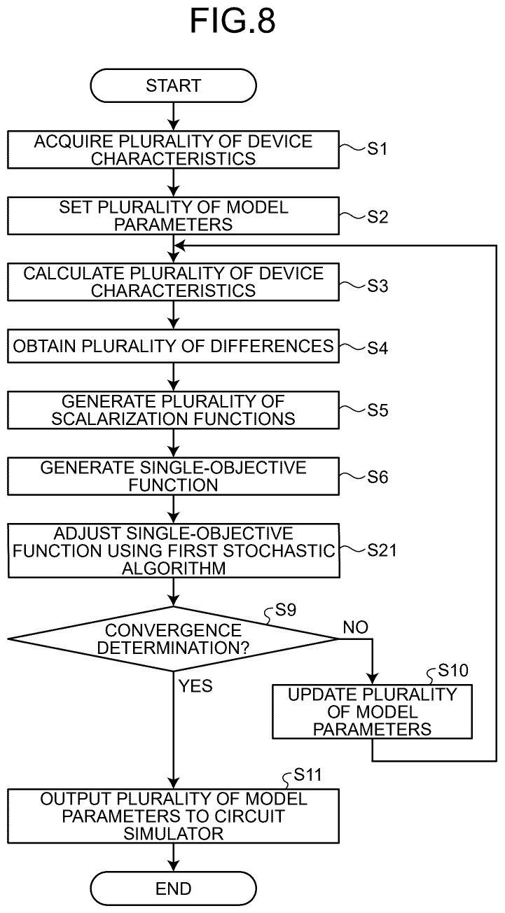

For example, as a first modification of the embodiment, as illustrated in FIG. 8, the processing of adjusting the multiple model parameters may be performed in a single stage using the first stochastic algorithm. FIG. 8 is a flowchart illustrating a circuit simulation method according to the first modification of the embodiment.

In S21, the information processing apparatus 1 adjusts (e.g., optimizes) the single-objective function using the first stochastic algorithm and obtains multiple model parameters that minimize the single-objective function. For example, in a case where it is desired to adjust a specific Vth/Ion, the information processing apparatus 1 is capable of performing the model extraction processing (S200) illustrated in FIG. 8.

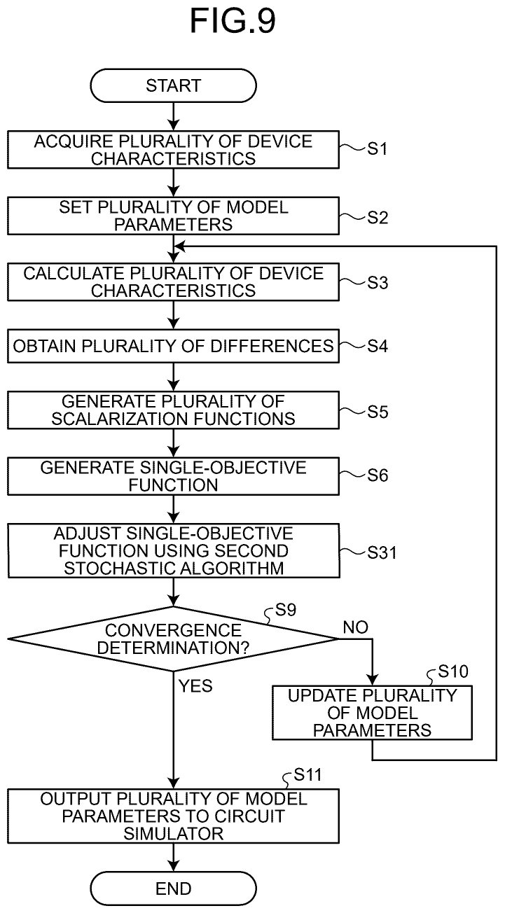

Alternatively, as a second modification of the embodiment, as illustrated in FIG. 9, the processing of adjusting the multiple model parameters may be performed in a single stage using the second stochastic algorithm. FIG. 9 is a flowchart illustrating a circuit simulation method according to the second modification of the embodiment.

In S31, the information processing apparatus 1 adjusts (e.g., optimizes) the single-objective function using the second stochastic algorithm and obtains multiple model parameters that minimize the single-objective function. For example, in a case where it is desired to fine-tune each of the multiple model parameters, the information processing apparatus 1 is capable of performing the model extraction processing (S200) illustrated in FIG. 9.

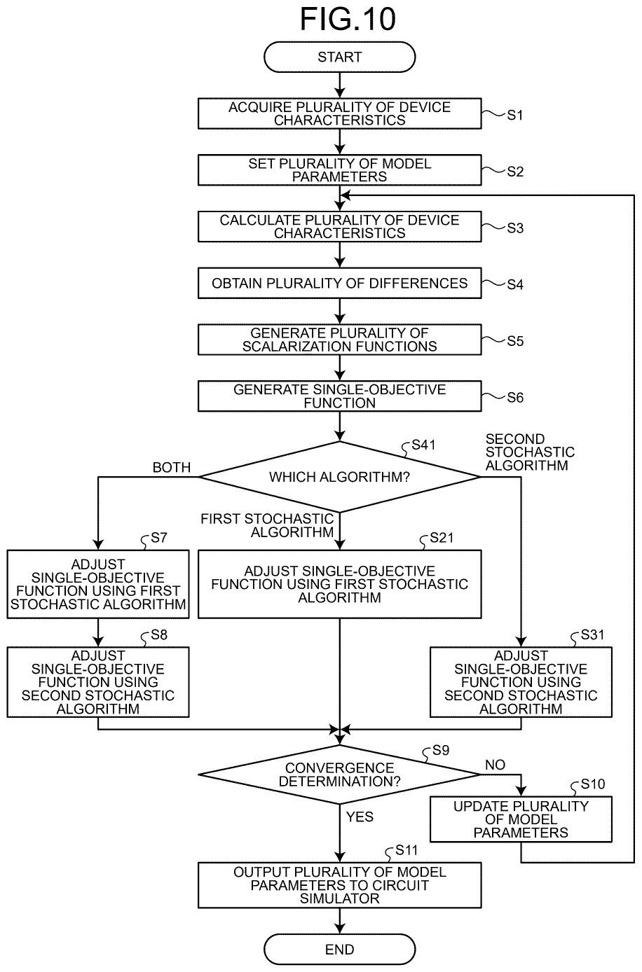

Alternatively, as a third modification of the embodiment, as illustrated in FIG. 10, in the model extraction processing (S200), the details of the processing of adjusting the multiple model parameters may be switched between single-stage and two-stage procedures depending on a result of the convergence determination (S9). FIG. 10 is a flowchart illustrating a circuit simulation method according to the third modification of the embodiment.

In S41, the information processing apparatus 1 determines which algorithm is to be used.

The information processing apparatus 1 determines that, if it is the first iteration or if the result of the previous convergence determination (S9) indicates a significant need for adjustment to achieve convergence, both the first stochastic algorithm and the second stochastic algorithm are to be used (“both” in S41) and then performs S7 and S8 sequentially, followed by proceeding to the convergence determination (S9).

The information processing apparatus 1 determines that, if the result of the previous convergence determination (S9) indicates a moderate need for adjustment to achieve convergence, the first stochastic algorithm is to be used (“first stochastic algorithm” in S41), performs S21, and then proceeds to the convergence determination (S9).

The information processing apparatus 1 determines that, if the result of the previous convergence determination (S9) indicates a minor need for adjustment to achieve convergence, the second stochastic algorithm is to be used (“second stochastic algorithm” in S41), performs S31, and then proceeds to the convergence determination (S9).

This allows the model extraction processing (S200) to be carried out efficiently depending on the result of the convergence determination (S9).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A circuit simulation method comprising:
acquiring multiple device characteristics under an operating terminal condition;
setting multiple model parameters corresponding to the multiple device characteristics;
obtaining a single-objective function including the multiple model parameters;
minimizing the single-objective function and adjusting the multiple model parameters; and
outputting the multiple adjusted model parameters to a circuit simulator.

2. The circuit simulation method according to claim 1, further comprising:
performing a convergence determination on the multiple adjusted model parameters; and
iterating the obtaining of the single-objective function and the adjusting of the multiple model parameters if the multiple adjusted model parameters is not converged.

3. The circuit simulation method according to claim 1, wherein
the obtaining of the single-objective function includes,
calculating the multiple device characteristics under the operating terminal condition using the multiple model parameters, and
generating the single-objective function using multiple differences between the multiple acquired device characteristics and the multiple calculated device characteristics.

4. The circuit simulation method according to claim 1, wherein
the generating of the single-objective function includes,
generating multiple scalarization functions using the multiple differences, and
generating the single-objective function that includes the multiple scalarization functions.

5. The circuit simulation method according to claim 1, wherein the generating of the single-objective function includes,
generating multiple scalarization functions using the multiple differences, and
generating the single-objective function by taking a weighted root mean square of the multiple scalarization functions.

6. The circuit simulation method according to claim 4, wherein
the generating of the multiple scalarization functions includes,
generating the multiple scalarization functions by performing a weighted summation of the multiple differences.

7. The circuit simulation method according to claim 5, wherein
the generating of the multiple scalarization functions includes,
generating the multiple scalarization functions by performing a weighted summation of the multiple differences.

8. The circuit simulation method according to claim 1, wherein
the adjusting of the multiple model parameters includes,
obtaining, using a stochastic algorithm, the multiple model parameters that minimize the single-objective function.

9. The circuit simulation method according to claim 8, wherein
the adjusting of the multiple model parameters includes,
searching for, using a first stochastic algorithm, an initial value for the single-objective function, and
obtaining, using a second stochastic algorithm, the multiple model parameters that minimize the single-objective function with the searched initial value.

10. The circuit simulation method according to claim 8, wherein
the adjusting of the multiple model parameters includes,
obtaining, using a first stochastic algorithm, the multiple model parameters that minimize the single-objective function.

11. The circuit simulation method according to claim 8, wherein
the adjusting of the multiple model parameters includes,
obtaining, using a second stochastic algorithm, the multiple model parameters that minimize the single-objective function with the searched initial value.

12. The circuit simulation method according to claim 8, further comprising:
performing a convergence determination on the multiple adjusted model parameters; and
determining a stochastic algorithm that is to be used for adjusting the multiple model parameters depending on a result of the convergence determination.

13. The circuit simulation method according to claim 9, wherein
the first stochastic algorithm includes a NPSA (Neighborhood Parallel Simulated Annealing) algorithm, and
the second stochastic algorithm includes an ADAM (ADAptive Moment estimation) algorithm.

14. The circuit simulation method according to claim 10, wherein
the first stochastic algorithm includes a NPSA (Neighborhood Parallel Simulated Annealing) algorithm.

15. The circuit simulation method according to claim 11, wherein
the second stochastic algorithm includes an ADAM (ADAptive Moment estimation) algorithm.

16. The circuit simulation method according to claim 1, wherein
the acquiring includes,
performing a measurement on a device under the operating terminal condition and acquiring the multiple device characteristics under the operating terminal condition.

17. The circuit simulation method according to claim 1, further comprising:
setting, by the circuit simulator, the multiple adjusted model parameters in a circuit simulation program.

18. The circuit simulation method according to claim 1, wherein
the operating terminal condition includes a gate voltage, a drain voltage, a substrate voltage, and a source voltage applied to a device during measurement.

19. The circuit simulation method according to claim 1, wherein
the multiple device characteristics includes gate voltage-drain current characteristics, drain voltage-drain current characteristics, substrate voltage-threshold voltage characteristics, gate length-threshold voltage characteristics, gate width-threshold current characteristics, temperature-threshold current characteristics, base voltage-on current characteristics, gate length-on current characteristics, gate width-on current characteristics, temperature-on current characteristics, gate voltage-gate capacitance characteristics, drain voltage-gate capacitance characteristics, and substrate voltage-substrate capacitance characteristics.

20. The circuit simulation method according to claim 1, wherein
the multiple model parameters include multiple SPICE (Simulation Program with Integrated Circuit Emphasis) parameters.
